(19) United States
(12) Patent Application Publication
(10) Pub. No.: US 2017/0012452 A1
(43) Pub. Date: Jan. 12, 2017

(54) BIDIRECTIONAL DC/DC CONVERTER

(71) Applicant: POSTECH ACADEMY-INDUSTRY FOUNDATION, Pohang-si (KR)

(72) Inventors: Bong Koo KANG, Pohang-si (KR); Sang Won LEE, Daejeon-si (KR); Kyung Min LEE, Daejeon-si (KR); Yoon Geol CHOI, Seoul (KR)

(73) Assignee: POSTECH ACADEMY-INDUSTRY FOUNDATION, Pohang-si (KR)

(21) Appl. No.: 15/204,039

(22) Filed: Jul. 7, 2016

(30) Foreign Application Priority Data
Jul. 10, 2015 (KR) 10-2015-0098231

(51) Int. Cl. H02J 7/00; H02M 1/14; H02M 3/335

(52) U.S. Cl. CPC H02J 7/0068; H02M 3/33507; H02J 7/0052; H02M 1/14; H02J 2007/0059

(57) ABSTRACT

The present invention relates to a technology for implementing a bidirectional DC/DC converter in an ESS (Energy Storage System). According to the present invention, a two-phase interleaving technique and a ZVS (Zero Voltage Switching) cell are used to implement a high-efficiency bidirectional DC/DC converter, high-efficiency energy conversion can be performed through a plurality of voltage transformation processes, ripple can be reduced to stably exchange energy, the interleaving technique is used to reduce input current ripple and output voltage ripple, and conduction loss can be reduced under a relatively high load.

### BACKGROUND

1. Technical Field

The present disclosure relates to a technology for implementing a bidirectional DC/DC converter using a two-phase interleaving technique and a ZVS (Zero Voltage Switching) cell in an energy storage system, and more particularly, to a bidirectional DC/DC converter which is capable of reducing an input current ripple and an output voltage ripple through an interleaving technique, reducing conduction loss under a relatively high load, and operating switches according to the ZVS method.

2. Related Art

An ESS (Energy Storage System) includes a PCS (Power Conversion System), a BMS (Battery Management System), and an EMS (Energy Management System) for controlling the ESS.

The PCS serves to convert power supplied from various energy sources into commercial AC power or power suitable for being stored in a battery cell. At this time, energy conversion is required between the battery cell and the voltage of a DC link. The energy conversion is performed by a PCS referred to as a bidirectional DC/DC converter.

In general, battery cells are connected in series or parallel and used as an energy source. When the battery cells connected in such a manner are used as an energy source, large ripple may be generated while the battery cells are charged/discharged. In this case, the ripple has a bad influence on the lifespan of the battery cells. Therefore, when the current ripple is reduced in the battery cells used as an energy source, the lifespan of the battery cells is extended as much.

Furthermore, when a bidirectional DC/DC converter are implemented with elements having a smaller size, the use of a switching frequency higher than a predetermined frequency is required. In a general hard switching technique, however, a high frequency causes a large switching loss, thereby having a bad influence on efficiency.

Recently, there has been proposed a ZVS method which is a kind of soft switching technique capable of driving a DC/DC converter without generating heat even at higher efficiency.

FIG. 1 is a circuit diagram of a conventional bidirectional buck boost DC/DC converter. As illustrated in FIG. 1, the bidirectional buck boost DC/DC converter includes a DC link V_{DC}, switches Q11 and Q12, an inductor L11 and a battery cell module (battery pack) 11. The switches Q11 and Q12 are implemented with MOS transistors, and the battery cell module 11 includes battery cells coupled in series and parallel.

Referring to FIG. 1, the pair of switches Q11 and Q12 are complementarily operated in a charge/discharge mode. Thus, power of the DC link VDC is stored in the battery cell module through the inductor L11, or the power stored in the battery cell module 11 is discharged.

The conventional buck boost DC/DC converter has advantages in that the basic structure thereof is simple and the charge/discharge control structure for the battery cell module is simple. However, since the voltage conversion efficiency is low, the battery cell module requires a large number of battery cells coupled in series. Furthermore, since the conventional buck boost DC/DC converter performs a hard switching operation to charge/discharge the battery cell module, a lot of heat is generated, thereby reducing the efficiency.

FIG. 2 is a circuit diagram of a conventional flyback DC/DC converter. As illustrated in FIG. 2, the conventional flyback DC/DC converter includes switches Q21 and Q22, inductors L21 to L23, a transformer TR21 and a battery cell module 21. The switches Q21 and Q22 are implemented with MOS transistors, and the battery cell module 21 includes battery cells coupled in series and parallel.

Referring to FIG. 2, the pair of switches Q21 and Q22 are complementarily operated in a charge/discharge mode. Thus, power of the DC link V_{DC} is stored in the battery cell module 21 through the inductors L21 to L23 and the transformer TR21, or the power stored in the battery cell module 21 is discharged.

The conventional flyback DC/DC converter has advantages in that the DC link V_{DC} and the battery cell module can be insulated by the transformer and the turn ratio of the transformer can be adjusted to control a voltage gain. However, since power is transferred through the transformer, the cost and size of a product is increased.

FIG. 3 is a circuit diagram of a conventional dual active bridge bidirectional converter. As illustrated in FIG. 3, the conventional dual active bridge bidirectional converter includes a first bridge circuit 31, a second bridge circuit 32 and a transformer TR31. The first and second bridge circuits 31 and 32 may be configured in the form of a full bridge including four switches or a half bridge including two switches.

Referring to FIG. 3, the first bridge circuit 31 is connected to a first DC link V_{H}, the second bridge circuit 32 is connected to a second DC link V_{L}, and the first and second bridge circuits 31 and 32 are connected through the transformer TR31.

The conventional dual active bridge bidirectional converter has an advantage in that the DC link and the battery cell module can be insulated from each other. However, a larger number of switches are used to construct the bridge circuits.

### SUMMARY

Various embodiments are directed to a high-efficiency bidirectional DC/DC converter using a two-phase interleaving technique and a ZVS cell, which is capable of converting electrical energy through a plurality of voltage transformation processes and stably exchanging energy.

In an embodiment, a bidirectional DC/DC converter may include: a first leg including a pair of switches connected in series between a negative terminal and a positive terminal of a DC link; a second leg including a pair of switches connected in series between the negative terminal and the positive terminal of the DC link; an LC resonance unit including an inductor and a capacitor which are connected in series between a first node to which the pair of switches of the first leg are connected and a second node to which the pair of switches of the second leg are connected, and configured to perform an LC series resonance function on a DC voltage which is converted in both directions; and an electrical energy transfer unit including a first inductor connected between the first node and a positive terminal of a battery cell power supply and a second inductor connected between the second node and the positive terminal of the battery cell power supply, and configured to transfer electrical energy to the first and second legs.

### BRIEF DESCRIPTION OF THE DRAWINGS

FIG. 1 is a circuit diagram of a conventional bidirectional buck boost DC/DC converter.

FIG. 2 is a circuit diagram of a conventional flyback DC/DC converter.

FIG. 3 is a circuit diagram of a conventional dual active bridge bidirectional converter.

FIG. 4 is a circuit diagram of a bidirectional DC/DC converter according to an embodiment of the present invention.

FIG. 5 is a waveform diagram of the respective units when the bidirectional DC/DC converter of FIG. 4 is driven in a buck converter mode.

FIGS. 6A to 6H are circuit diagrams illustrating the operation states of the respective units when the bidirectional DC/DC converter of FIG. 4 is driven in the buck converter mode.

FIG. 7 is a waveform diagram of the respective units when the bidirectional DC/DC converter 40 of FIG. 4 is driven in a boost converter mode.

FIGS. 8A to 8H are circuit diagrams illustrating the operation states of the respective units when the bidirectional DC/DC converter of FIG. 4 is driven in the boost converter mode.

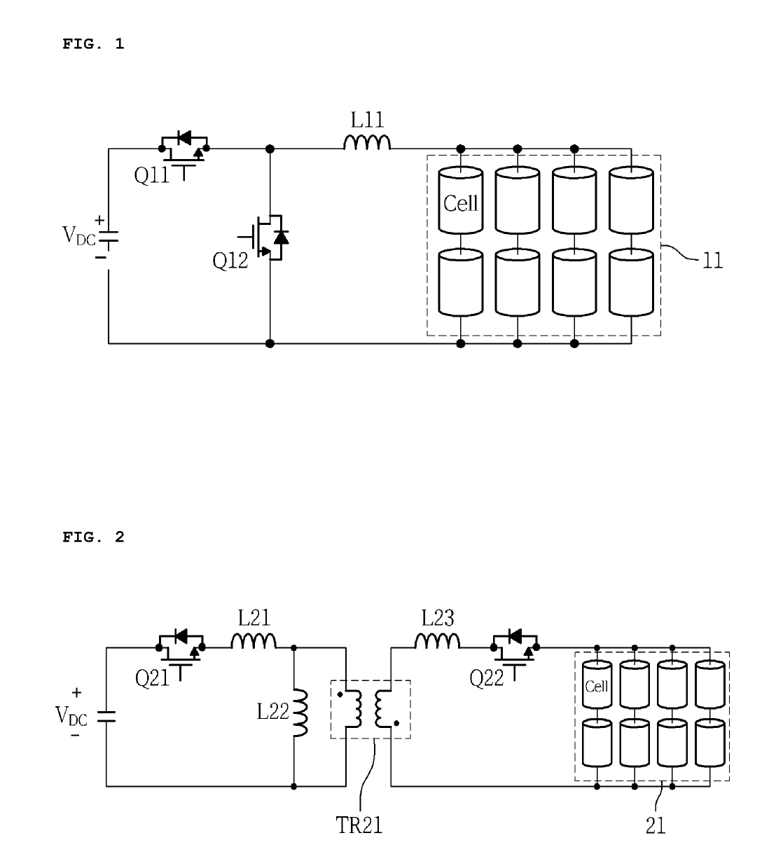

### DETAILED DESCRIPTION

Hereafter, exemplary embodiments will be described below in more detail with reference to the accompanying drawings.

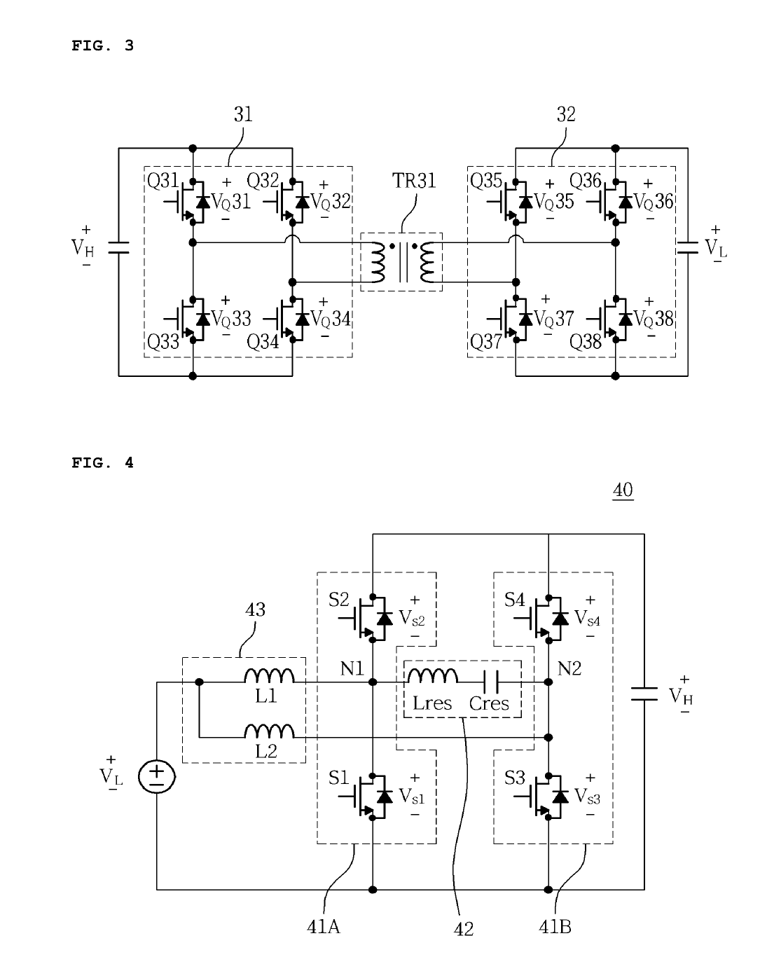

FIG. 4 is a circuit diagram of a bidirectional DC/DC converter according to an embodiment of the present invention. As illustrated in FIG. 4, the bidirectional DC/DC converter 40 includes a first leg 41A, a second leg 41B, an LC resonance unit 42, and an electrical energy transfer unit 43. The first leg 41A includes a pair of switches S1 and S2 connected in series between a negative terminal (−) and a positive terminal (+) of a DC link V_{H}. The second leg 41B includes a pair of switches S3 and S4 connected in series between the negative terminal (−) and the positive terminal (+) of the DC link V_{H}. The LC resonance unit 42 includes an inductor Lres and a capacitor Cᵣₑₛ which are connected in series between a first node N1 to which the pair of switches S1 and S2 of the first leg 41A are connected and a second node N2 to which the pair of switches S3 and S4 of the second leg 42A are connected. The electrical energy transfer unit 43 includes an inductor L1 connected between the first node N1 and a positive terminal (+) of a battery cell power supply V_{L} and an inductor L2 connected between the second node N2 and the positive terminal (+) of the battery cell power supply V_{L}, and transfers electrical energy to the first and second legs 41A and 41B.

First, a ZVS (Zero Voltage Switching) operation is performed according to the following principle.

When an arbitrary switch among the switches S1 to S4 is turned off by electrical energy transferred through the inductors L1 and L2 of the electrical energy transfer unit 43 and the inductor Lres and the capacitor Cᵣₑₛ of the LC resonance unit 42, a parasitic capacitor of the corresponding switch is discharged. Then, a current is passed through a body diode connected in parallel to the corresponding switch among the switches S1 to S4. At this time, when the corresponding switch among the switches S1 to S4 is turned on, the ZVS operation can be performed. Thus, the DC/DC conversion efficiency of all loads is improved. The type of the switches S1 to S4 is not limited, but a MOS FET (Metal Oxide Field Effect Transistor) as a majority carrier may be used in order to maximize the efficiency of the ZVS operation.

When the bidirectional DC/DC converter 40 is operated in a battery cell module charge mode (buck converter mode) or battery cell module discharge mode (boost converter mode), the first and second legs 41A and 41B may be interleaved with a 180-degree phase shift, and thus reduce input current ripple, output voltage ripple and conduction loss.

The reason why ripple can be reduced is that the first and second legs 41A and 41B transfer electrical energy with a phase difference of 180 degrees. For example, when the duty ratio of electrical energy to be transferred is 0.5, the magnitude of ripple can be halved by the electrical energy transfer. Furthermore, the reason why conduction loss can be reduced is that the electrical energy is divided and transferred through the two inductors L1 and L2. As the load is increased, the reduction of conduction loss is larger than the reduction of switching loss.

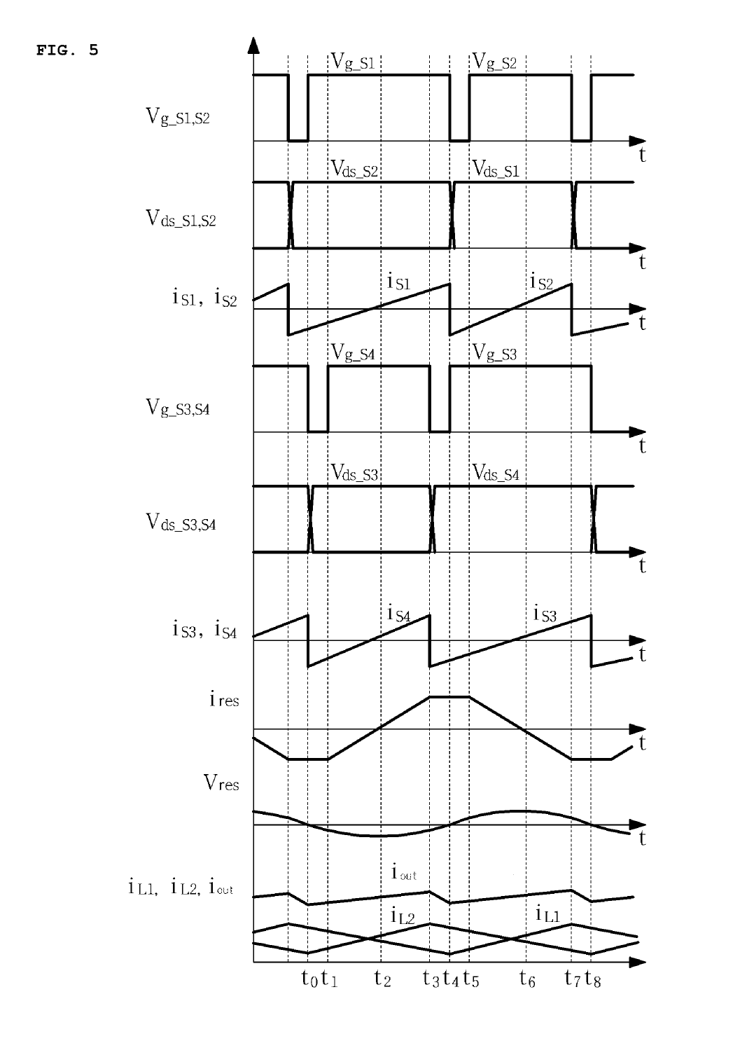

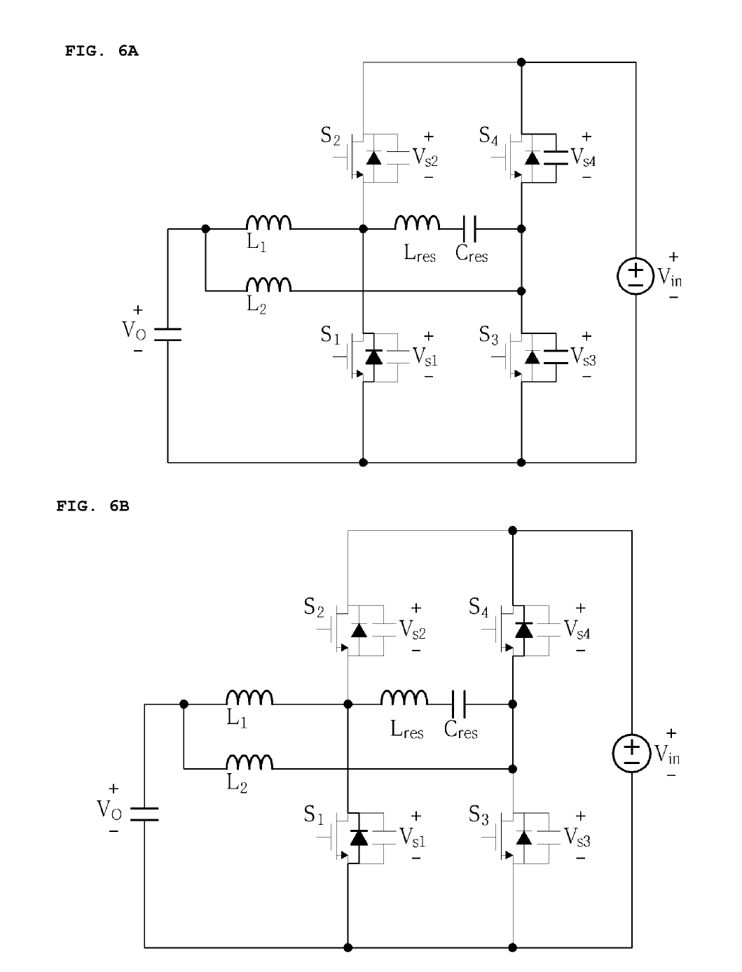

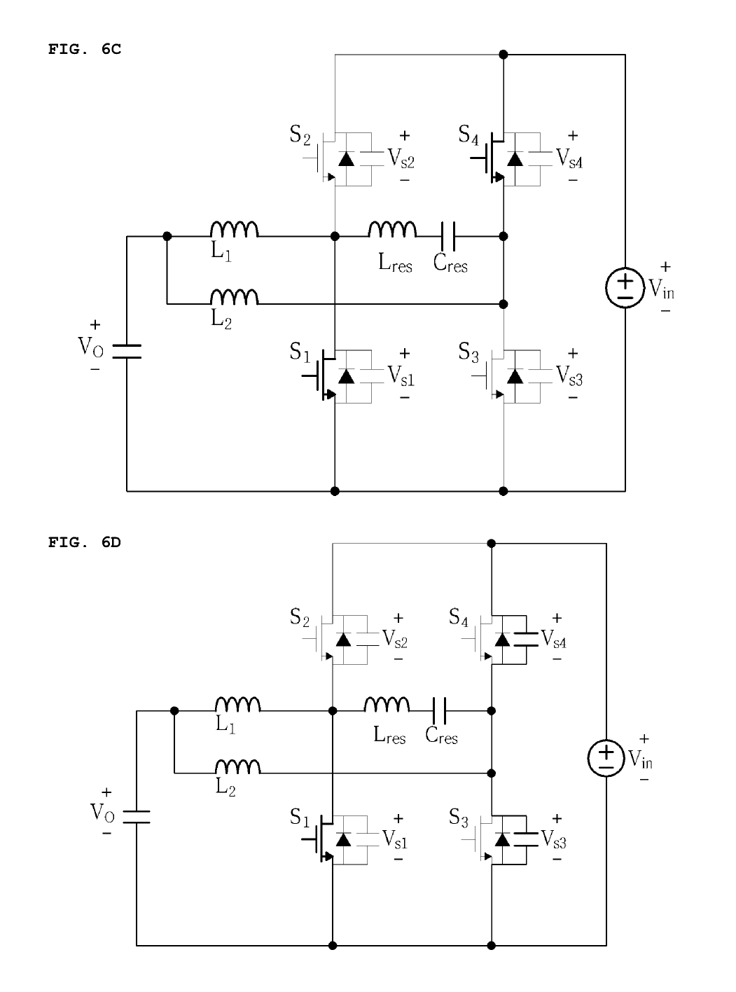

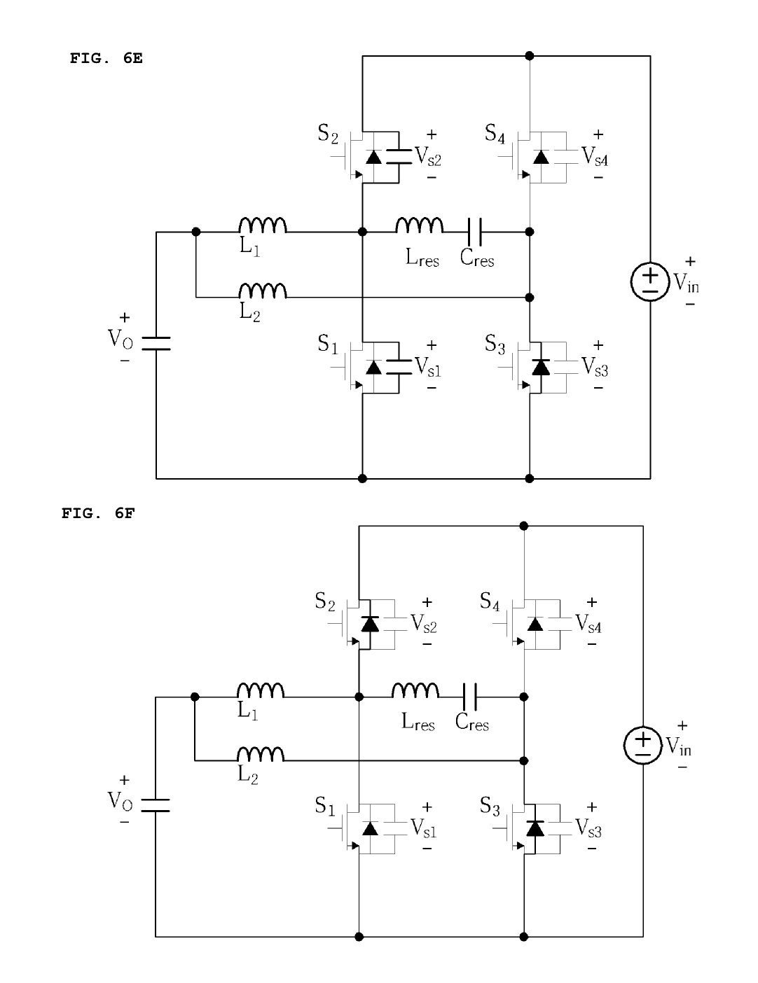

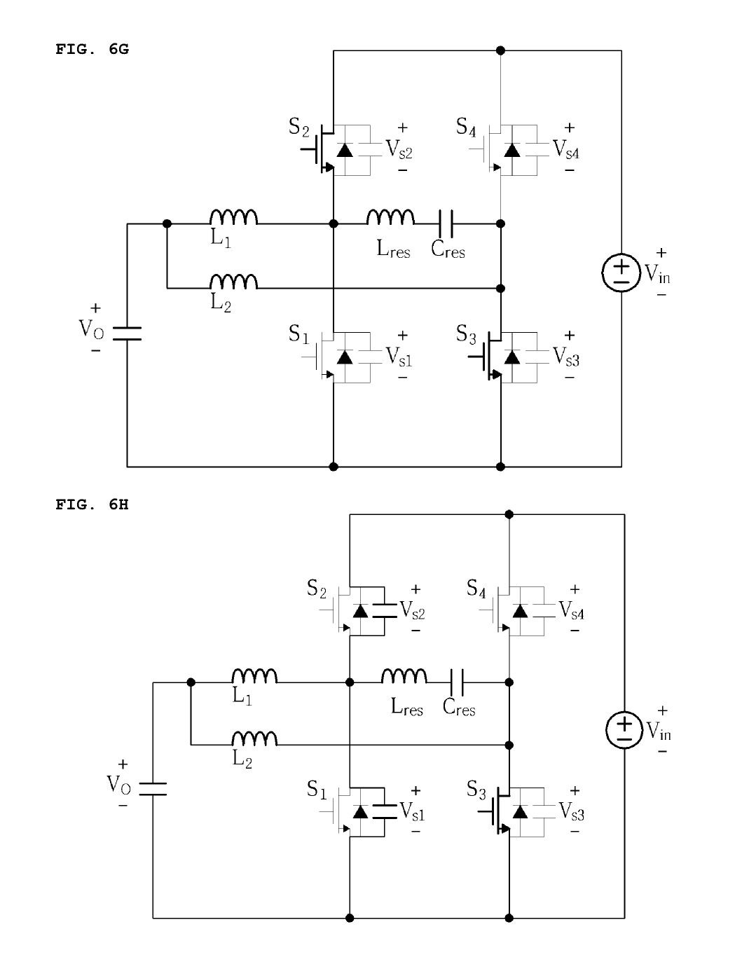

FIG. 5 is a waveform diagram of the respective units when the bidirectional DC/DC converter 40 of FIG. 4 is driven in the buck converter mode. FIGS. 6A to 6H are circuit diagrams illustrating the operation states of the respective units when the bidirectional DC/DC converter 40 of FIG. 4 is driven in the buck converter mode.

The operation of the buck converter mode for charging the battery cell module connected to the battery cell power supply Vᵢₙ with DC power supplied to the DC link V_{O} will be described with reference to FIGS. 5 and 6. The switches S1 to S4 which are implemented with MOS transistors in FIG. 4 are turned on by gate voltages V_{g}_{_}ₛ₁ to V_{g}_{_}ₛ₄ supplied from a controller (not illustrated), respectively.

In a first mode Mode1 from t0 to t1, the switch S1 is turned on by the ‘high’ gate voltage V_{g}_{_}ₛ₁ after a current is passed through the body diode connected in parallel. Thus, the ZVS operation can be performed. At this time, the parasitic capacitor of the switch S3 is charged with electrical energy, and the parasitic capacitor of the switch S4 is discharged. Then, the switch S3 is turned off by the ‘low’ gate voltage V_{g}_{_}ₛ₃, and the capacitor Cᵣₑₛ of the LC resonance unit 42 is discharged. At this time, the electrical energy stored in the inductor L1 of the electrical energy transfer unit 43 is discharged to the battery cell power supply Vᵢₙ, and the inductor L2 is charged with electrical energy.

In a second mode Mode2 from t1 to t2, the switch S4 is turned on by the ‘high’ gate voltage V_{g}_{_}ₛ₄ after the parasitic capacitor of the switch S4 is discharged and a current is passed through the body diode connected in parallel to the switch S4 as in the first mode. Thus, the ZVS operation can be performed. At this time, the discharging operation for the capacitor Cᵣₑₛ of the LC resonance unit 42 is ended. The electrical energy stored in the inductor L1 of the electrical energy transfer unit 43 is discharged to the battery cell power supply Vᵢₙ, and the inductor L2 is charged with electrical energy.

In a third mode Mode3 from t2 to t3, the capacitor Cᵣₑₛ of the LC resonance unit 42 starts to be charged with electrical energy. At this time, the electrical energy stored in the inductor L1 of the electrical energy transfer unit 43 is discharged to the battery cell power supply Vᵢₙ, and the inductor L2 is charged with electrical energy.

In a fourth mode Mode4 from t3 to t4, the parasitic capacitor of the switch S3 is discharged, and the parasitic capacitor of the switch S4 is charged with electrical energy. Then, the switch S4 is turned off by the ‘low’ gate voltage V_{g}_{_}ₛ₄, and the capacitor Cᵣₑₛ of the LC resonance unit 42 is charged with electrical energy. Furthermore, the electrical energy stored in the inductors L1 and L2 of the electrical energy transfer unit 43 is discharged to the battery cell power supply Vᵢₙ.

In a fifth mode Mode5 from t4 to t5, the switch S3 is turned on by the ‘high’ gate voltage V_{g}_{_}ₛ₃ after a current is passed through the body diode connected in parallel. Thus, the ZVS operation can be performed. At this time, the parasitic capacitor of the switch S1 is charged with electrical energy, and the parasitic capacitor of the switch S2 is discharged. Then, the switch S1 is turned off by the ‘low’ gate voltage V_{g}_{_}ₛ₁, and the capacitor Cᵣₑₛ of the LC resonance unit 42 is charged with electrical energy. At this time, the inductor L1 of the electrical energy transfer unit 43 is charged with electrical energy, and electrical energy is discharged from the inductor L2.

In a sixth mode Mode6 from t5 to t6, the switch S2 is turned on by the ‘high’ gate voltage V_{g}_{_}ₛ₂ after a current is passed through the body diode connected in parallel. Thus, the ZVS operation can be performed. At this time, the charging operation for the capacitor Cᵣₑₛ of the LC resonance unit 42 is ended. Then, the inductor L1 of the electrical energy transfer unit 43 is charged with electrical energy, and electrical energy is discharged from the inductor L2.

In a seventh mode Mode1 from t6 to t7, the capacitor Cᵣₑₛ of the LC resonance unit 42 starts to be discharged. Then, the inductor L1 of the electrical energy transfer unit 43 is charged with electrical energy, and electrical energy is discharged from the inductor L2.

In an eighth mode Mode8 from t7 to t8, the parasitic capacitor of the switch S1 is discharged, and the parasitic capacitor of the switch S2 is charged with electrical energy. Then, the switch S2 is turned off by the ‘low’ gate voltage V_{g}_{_}ₛ₂, and the capacitor Cᵣₑₛ of the LC resonance unit 42 is discharged. At this time, electrical energy is discharged from the inductors L1 and L2 of the electrical energy transfer unit 43.

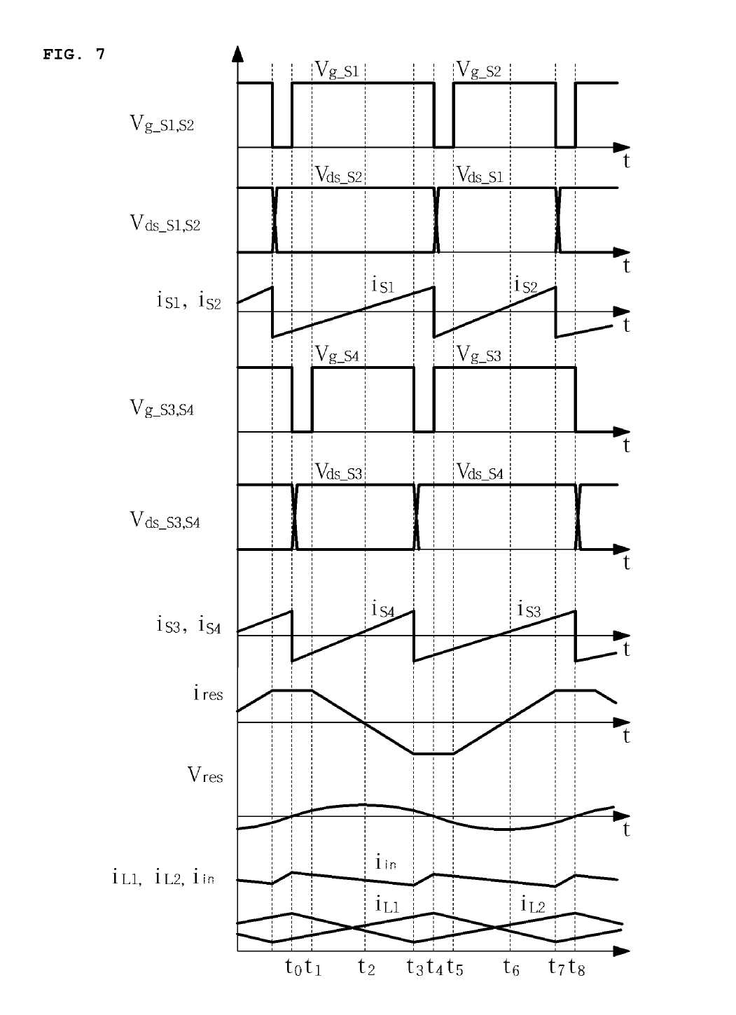

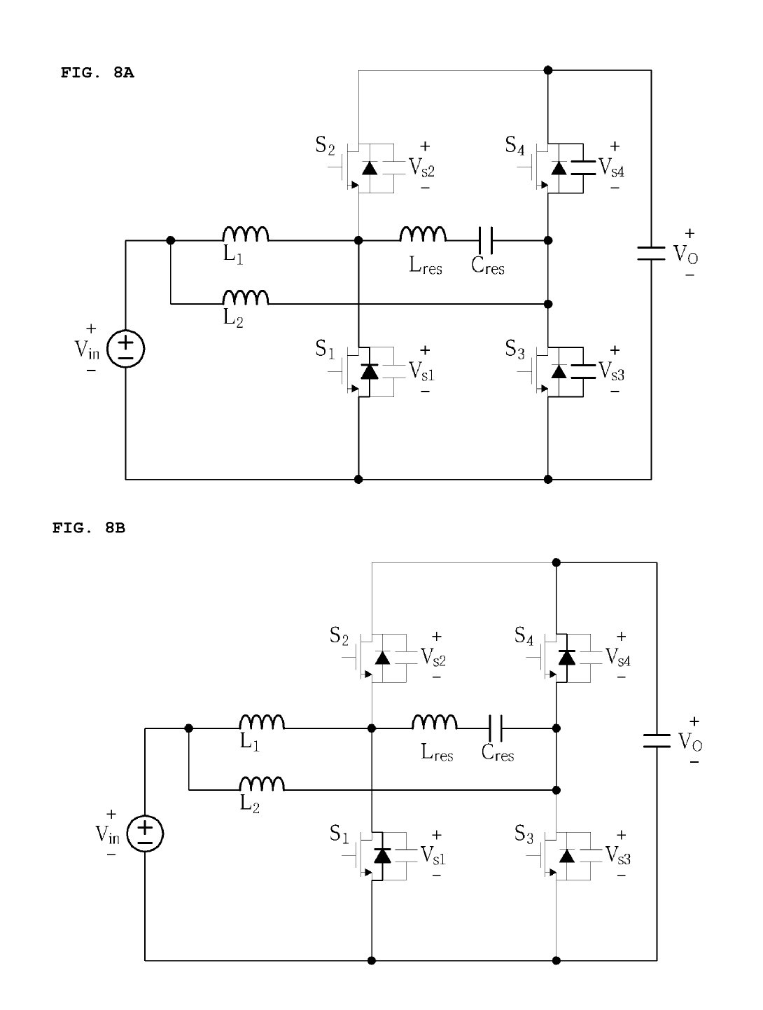

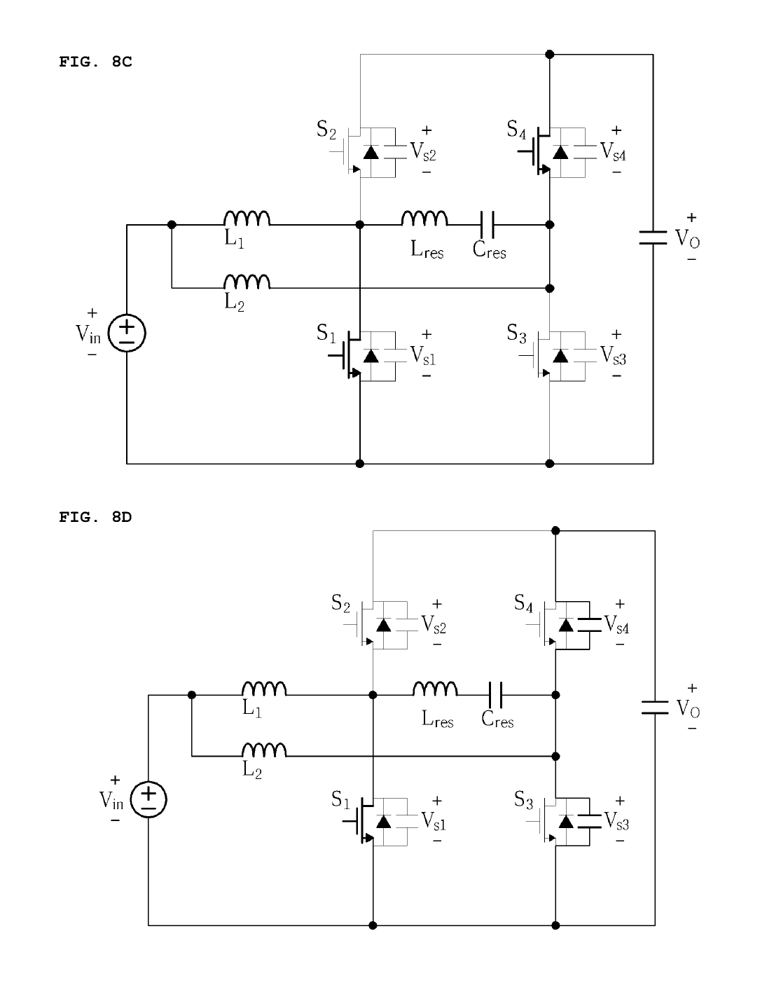

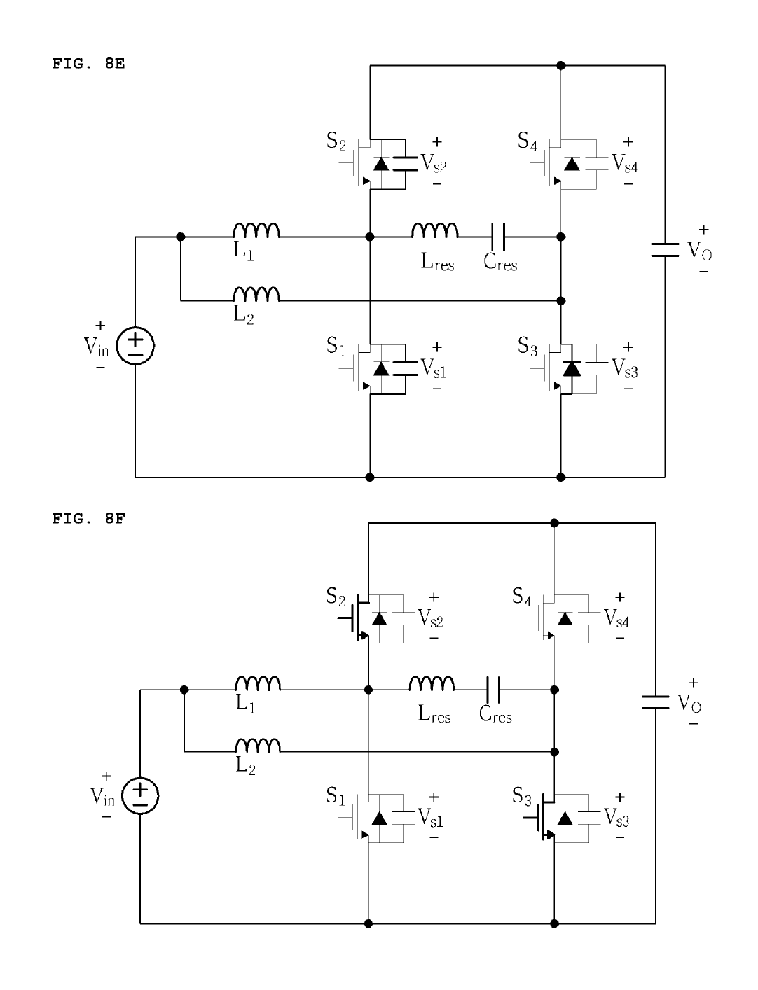

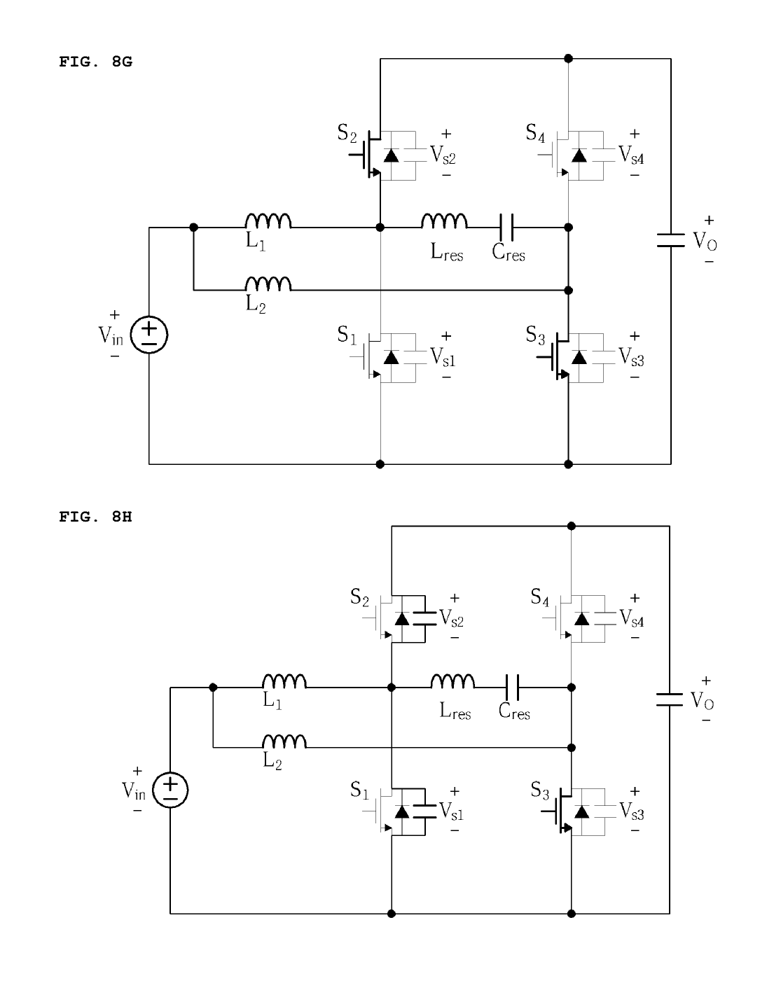

FIG. 7 is a waveform diagram of the respective units when the bidirectional DC/DC converter 40 of FIG. 4 is driven in the boost converter mode. FIGS. 8A to 8H are circuit diagrams illustrating the operation states of the respective units when the bidirectional DC/DC converter 40 of FIG. 4 is driven in the boost converter mode.

The operation of the boost converter mode for outputting (discharging) DC power supplied from the battery cell module through the battery cell power supply Vᵢₙ to the DC link V_{O} will be described with reference to FIGS. 7 and 8.

In a first mode Mode1 from t0 to t1, the switch S1 is turned on by the ‘high’ gate voltage V_{g}_{_}ₛ₁ after a current is passed through the body diode connected in parallel. Thus, the ZVS operation can be performed. At this time, the parasitic capacitor of the switch S3 is charged with electrical energy, and the parasitic capacitor of the switch S4 is discharged.

Then, the switch S3 is turned off by the ‘low’ gate voltage V_{g}_{_}ₛ₃, and the capacitor Cᵣₑₛ of the LC resonance unit 42 is charged with electrical energy. At this time, the inductor L1 of the electrical energy transfer unit 43 is charged with electrical energy, and electrical energy is discharged from the inductor L2.

In a second mode Mode2 from t1 to t2, the switch S4 is turned on by the ‘high’ gate voltage V_{g}_{_}ₛ₄ after the parasitic capacitor of the switch S4 is discharged and a current is passed through the body diode connected in parallel to the switch S4 as in the first mode. Thus, ZVS can be performed. At this time, the charging operation for the capacitor Cᵣₑₛ of the LC resonance unit 42 is ended. Then, the inductor L1 of the electrical energy transfer unit 43 is charged with electrical energy, and electrical energy is discharged from the inductor L2.

In a third mode Mode3 from t2 to t3, the capacitor Cᵣₑₛ of the LC resonance unit 42 starts to be discharged. At this time, the inductor L1 of the electrical energy transfer unit 43 is charged with electrical energy, and electrical energy is discharged from the inductor L2.

In a fourth mode Mode4 from t3 to t4, the parasitic capacitor of the switch S3 is discharged, and the parasitic capacitor of the switch S4 is charged with electrical energy. Then, the switch S4 is turned off by the ‘low’ gate voltage V_{g}_{_}ₛ₄, and the capacitor Cᵣₑₛ of the LC resonance unit 42 are discharged. Then, the inductors L1 and L2 of the electrical energy transfer unit 43 are charged with electrical energy.

In a fifth mode Mode5 from t4 to t5, the switch S3 is turned on by the ‘high’ gate voltage V_{g}_{_}ₛ₃ after a current is passed through the body diode connected in parallel. Thus, the ZVS operation can be performed. At this time, the parasitic capacitor of the switch S1 is charged with electrical energy, and the parasitic capacitor of the switch S2 is discharged. Then, the switch S1 is turned off by the ‘low’ gate voltage V_{g}_{_}ₛ₁, and the capacitor Cᵣₑₛ of the LC resonance unit 42 is discharged. At this time, electrical energy is discharged from the inductor L1 of the electrical energy transfer unit 43, and the inductor L2 is charged with electrical energy.

In a sixth mode Mode6 from t5 to t6, the switch S2 is turned on by the ‘high’ gate voltage V_{g}_{_}ₛ₂ after a current is passed through the body diode connected in parallel. Thus, the ZVS operation can be performed. At this time, the discharging operation for the capacitor Cᵣₑₛ of the LC resonance unit 42 is ended. Then, electrical energy is discharged from the inductor L1 of the electrical energy transfer unit 43, and the inductor L2 is charged with electrical energy.

In a seventh mode Mode1 from t6 to t7, the capacitor Cᵣₑₛ of the LC resonance unit 42 starts to be charged with electrical energy. Then, electrical energy is discharged from the inductor L1 of the electrical energy transfer unit 43, and the inductor L2 is charged with electrical energy.

In an eighth mode Mode8 from t7 to t8, the parasitic capacitor of the switch S1 is discharged, and the parasitic capacitor of the switch S2 is charged with electrical energy. Then, the switch S2 is turned off by the ‘low’ gate voltage V_{g}_{_}ₛ₂, and the capacitor Cᵣₑₛ of the LC resonance unit 42 are charged with electrical energy. At this time, the inductors L1 and L2 of the electrical energy transfer unit 43 are charged with electrical energy.

The bidirectional DC/DC converter 40 has the same voltage conversion ratio as the conventional non-isolated bidirectional DC/DC converter. That is, the voltage conversion ratio of the boost converter mode according to the present embodiment may be expressed as Equation 1 below, and the voltage conversion ratio of the buck converter mode may be expressed as Equation 2 below.

$${V}_{high} = {V}_{low} \frac{1}{1 - D} \qquad [ Equation 1 ]$$

In Equation 1, “V_{high}” represents the voltage of the DC link V_{H} in FIG. 4, “V_{low}” represents the voltage of the battery cell power supply V_{L} in FIG. 4, and “D” represents a duty cycle indicating the ratio of the time during which a main switch is turned on to the entire cycle. In the boost converter mode, the switches S1 and S3 serve as the main switches, and in the buck converter mode, the switches S2 and S4 serve as the main switches.

V_{low}=V_{high}D [Equation 2]

In Equation 2, “V_{high}” represents the voltage of the DC link V_{H} in FIG. 4, “V_{low}” represents the voltage of the battery cell power supply V_{L} in FIG. 4, and “D” represents a duty cycle indicating the ratio of the time during which a main switch is turned on to the entire cycle. In the boost converter mode, the switches S1 and S3 serve as the main switches, and in the buck converter mode, the switches S2 and S4 serve as the main switches.

According to the embodiment of the present invention, it is possible to implement the high-frequency bidirectional DC/DC converter using the two-phase interleaving technique and the ZVS cell.

Furthermore, the bidirectional DC/DC converter can perform energy conversion with high efficiency through the plurality of voltage transformation processes, and reduce ripple to stably exchange energy.

Furthermore, the bidirectional DC/DC converter can reduce input current ripple and output voltage ripple using the interleaving technique, and reduce conduction loss under a relatively high load.

Furthermore, the bidirectional DC/DC converter can be applied to a power converter such as an ESS, an electrical vehicle, an electrical scooter or an electrical bicycle, which requires bidirectional energy exchange, thereby improving electrical energy efficiency and reducing ripple.

While various embodiments have been described above, it will be understood to those skilled in the art that the embodiments described are by way of example only. Accordingly, the disclosure described herein should not be limited based on the described embodiments.

What is claimed is:

1. A bidirectional DC/DC converter comprising:
a first leg comprising a pair of switches connected in series between a negative terminal and a positive terminal of a DC link;
a second leg comprising a pair of switches connected in series between the negative terminal and the positive terminal of the DC link;
an LC resonance unit comprising an inductor and a capacitor which are connected in series between a first node to which the pair of switches of the first leg are connected and a second node to which the pair of switches of the second leg are connected, and configured to perform an LC series resonance function on a DC voltage which is converted in both directions; and
an electrical energy transfer unit comprising a first inductor connected between the first node and a positive terminal of a battery cell power supply and a second inductor connected between the second node and the positive terminal of the battery cell power supply, and configured to transfer electrical energy to the first and second legs.

2. The bidirectional DC/DC converter of claim 1, wherein the battery cell power supply is connected to a battery cell module which includes a plurality of solar battery cells to convert solar light into electrical energy.

3. The bidirectional DC/DC converter of claim 1, wherein the bidirectional DC/DC converter transfers electrical energy of the DC link to the battery cell power supply or transfers electrical energy of the battery cell power supply to the DC link.

4. The bidirectional DC/DC converter of claim 1, wherein the switch comprises a MOS FET (Metal Oxide Field Effect Transistor).

5. The bidirectional DC/DC converter of claim 4, wherein the switch is connected in parallel to a body diode.

6. The bidirectional DC/DC converter of claim 5, wherein when the switch is turned off, the switch is zero-voltage-switched after a parasitic capacitor thereof is discharged and a current is passed through the body diode.

7. The bidirectional DC/DC converter of claim 6, wherein when the switch is zero-voltage-switched, the LC resonance unit is used.

8. The bidirectional DC/DC converter of claim 1, wherein when the bidirectional DC/DC converter is operated in a battery cell module charge mode (buck converter mode) or battery cell module discharge mode (boost converter mode), the first and second legs are interleaved with a 180-degree phase shift.

9. The bidirectional DC/DC converter of claim 1, wherein the first and second legs transfer electrical energy with a phase difference of 180 degrees.

10. The bidirectional DC/DC converter of claim 9, wherein the first and second legs alternately perform the electrical energy charging operation and the electrical energy discharging operation with a phase difference of 180 degrees.

11. The bidirectional DC/DC converter of claim 1, wherein the voltage conversion ratio of the boost converter mode in the bidirectional DC/DC converter follows a first equation below, and the voltage conversion ratio of the buck converter mode follows a second equation below:
$${V}_{high} = {V}_{low} \frac{1}{1 - D}$$
$${V}_{low} = {V}_{high} D$$
where “V_{high}” represents the voltage of the DC link, “V_{low}” represents the voltage of the battery cell power supply, and “9” represents a duty cycle.
